(19) United States
(12) Patent Application Publication
(10) Pub. No.: US 2023/0116202 A1
(43) Pub. Date: Apr. 13, 2023

(54) Policy for Optimising Cell Parameters

(71) Applicant: Telefonaktiebolaget LM Ericsson (publ), Stockholm (SE)

(72) Inventors: Adriano Mendo Mateo, Malaga (ES); Juan Ramiro Moreno, Malaga (ES); Paulo Antonio Moreira Mijares, Malaga (ES); Jose Maria Ruiz Aviles, Malaga (ES); Jose Outes Carnero, Torremolinos (ES)

(21) Appl. No.: 17/908,142

(22) PCT Filed: Jul. 30, 2020
(86) PCT No.: PCT/EP2020/071598

§ 371 Date: Aug. 30, 2022

(30) Foreign Application Priority Data
Mar. 27, 2020 (EP) 20382240.8

(51) Int. Cl. H04W 24/02; H04W 24/10

(52) U.S. Cl. CPC H04W 24/02; H04W 24/10

(57) ABSTRACT

According to an aspect, there is provided a computer-implemented method of training a policy for use by a reinforcement learning, RL, agent (406) in a communication network, wherein the RL agent (406) is for optimising one or more cell parameters in a respective cell (404) of the communication network according to the policy, the method comprising: (i) deploying (1001) a respective RL agent (408) for each of a plurality of cells (404) in the communication network, the plurality of cells (404) including cells that are neighbouring each other, each respective RL agent (408) having a first iteration of the policy; (ii) operating (1003) each deployed RL agent (408) according to the first iteration of the policy to adjust or maintain one or more cell parameters in the respective cell (404); (iii) receiving (1005) measurements relating to the operation of each of the plurality of cells (404); and (iv) determining (1007) a second iteration of the policy based on the received measurements relating to the operation of each of the plurality of cells (404).

### TECHNICAL FIELD OF THE INVENTION

This disclosure relates to optimising one or more cell parameters in respective cells of a communication network, and in particular to training a policy for use by reinforcement learning (RL) agents in optimising the one or more cell parameters.

### BACKGROUND OF THE INVENTION

Cellular networks are very complex systems. Each cell has its own set of configurable parameters. Some of these parameters only affect the cell on or in which they are applied, so it is somehow straightforward to find an optimum value. However, there is another set of parameters whose change does not only affect the cell on which they are applied, but also all the neighbouring cells. Finding an optimum value for this type of parameter is not so straightforward, and it is one of the most challenging tasks when optimising cellular networks.

Two examples for these parameters are Remote Electrical Tilt (RET) and the Long Term Evolution (LTE) parameter “P0 Nominal PUSCH”. RET defines the antenna tilt of the cell, and changes in the RET can be performed remotely. By modifying the RET, the downlink (DL) Signal to Interference plus Noise Ratio (SINR) can be improved in the cell under modification, but at the same time, the SINR of the surrounding cells can be worsened, and vice versa. The LTE parameter “P0 Nominal PUSCH” defines the target power per resource block (RB) that the cell expects in the uplink (UL) communication from the User Equipment (UE) to the Base Station (BS). Increasing the “P0 Nominal PUSCH” in a cell may increase the UL SINR in the cell under modification, but at the same time, the UL SINR in the surrounding cells may decrease, and vice versa.

Therefore, there is a clear trade-off between the performance of the cell under modification and the performance of the surrounding cells. This trade-off is not easy to estimate, since it will vary case by case, making it difficult to solve the optimisation problem. The target is to optimise the global network performance by modifying parameters on a per-cell basis. In computational complexity theory, this kind of problem is considered as ‘NP-hard’ (non-deterministic polynomial-time hard).

One of the most-used approaches to solve this problem is to create a control system based on rules defined by an expert. In the paper “Self-tuning of Remote Electrical Tilts Based on Call Traces for Coverage and Capacity Optimization in LTE” by Victor Buenestado, Matias Toril, Salvador Luna-Ramirez, Jose Maria Ruiz-Aviles, and Adriano Mendo, IEEE Transactions on Vehicular Technology, vol. 66, no. 5, pp. 4315-4326, May 2017, a fuzzy rule-based solution is described for RET optimisation.

With the increase in the use of Artificial Intelligence (AI) and Machine Learning (ML) techniques, Reinforcement Learning (RL) has become a popular method to solve this type of problem. RL is an area of machine learning concerned with how software agents ought to take actions in an environment in order to maximise a reward. RL differs from supervised learning techniques in not requiring training data in the form of labelled input/output pairs, and in not needing to explicitly correct sub-optimal actions by the agent.

In “A Framework for Automated Cellular Network Tuning with Reinforcement Learning” by Faris B. Mismar, Jinseok Choi, and Brian L. Evans, arXiv:1808.05140v51, July 2019, a single RL agent for the whole network is proposed. In “Spectral-and Energy-Efficient Antenna Tilting in a HetNet using Reinforcement Learning” by Weisi Guo, Siyi Wang, Yue Wu, Jonathan Rigelsford, Xiaoli Chu, and Tim O'Farrell, IEEE Wireless Communications and Networking Conference (WCNC): MAC, 2013 and WO 2012/072445, multi-agent RL systems are described. In “Online Antenna Tuning in Heterogeneous Cellular Networks with Deep Reinforcement Learning” by Eren Balevi and Jeffrey G. Andrews, arXiv: 1903.06787v2, June 2019, a combination of multi-agent and single distributed agent is introduced. Finally, in “Self-Optimization of Capacity and Coverage in LTE Networks Using a Fuzzy Reinforcement Learning Approach” by R. Razavi, S. Klein and H. Claussen, 21st Annual IEEE International Symposium on Personal, Indoor and Mobile Radio Communications, pp. 1865-1870, 2010, and “Fuzzy Rule-Based Reinforcement Learning for Load Balancing Techniques in Enterprise LTE Femtocells” by Pablo Munoz, Raquel Barco, José María Ruiz-Avilés, Isabel de la Bandera, and Alejandro Aguilar, IEEE Transactions on Vehicular Technology, vol. 62, no. 5, pp. 1962-1973, June 2013, a fuzzy system is included as a continuous/discrete convertor in a previous stage before the RL agent.

Control systems defined by experts rely on the availability of that specific expert who defines the rules to be applied, and these rules are specific to the problem to be solved (i.e. the specific parameter, e.g. RET, P0 Nominal PUSCH, etc.). Also, those rules tend to be generic and not specific to the network environment in which they are executed, so a performance improvement penalty is paid for this generalisation. In “Self-Optimization of Capacity and Coverage in LTE Networks Using a Fuzzy Reinforcement Learning Approach”, a fuzzy system is used as a way to implement expert rules.

RL methods try to overcome the previous problems, but they introduce new ones. The first problem is that they require a training phase during which the performance is clearly worse than that of an expert system. FIG. 1 is a graph comparing the performance of an expert system and an RL agent-system over time. Initially, the performance of the RL agent is clearly worse than that of the expert system. However, as time passes and the RL agent starts to learn, the performance of the RL agent improves until eventually the observed performance of the RL agent beats the expert system. However, the initial performance of an RL agent during a training phase is typically not acceptable for use in real networks because it is likely to cause a significant system degradation.

A single agent controlling the whole network as in “A Framework for Automated Cellular Network Tuning with Reinforcement Learning” is hard to train, because the agent must learn the whole network with all the interactions between cells. Also, once the agent is trained, it is only valid for that specific (network deployment) scenario, making the transfer learning procedure quite difficult or almost impossible. Even in a simple case in which one site is added to the network, the agent must be trained again from the start.

Multi-agent RL systems as in “Spectral-and Energy-Efficient Antenna Tilting in a HetNet using Reinforcement Learning” or WO 2012/072445, in which each agent acts upon a single cell, are better from a transfer learning point of view. In the simple case in which a new site is integrated into the network, only the agents corresponding to the new site should be trained from the beginning, and the rest of the agents will be updated in an incremental way via the normal mechanisms in RL. The initial point for existing sites is the previous status, before the addition of the new site, which is much better than any random initialisation. However, in a completely new network, the transfer learning process is not so intuitive. Also, this multi-agent scenario is hard to train, due to the fact that agents must learn different policies with interactions between agents.

In “Online Antenna Tuning in Heterogeneous Cellular Networks with Deep Reinforcement Learning” a single distributed agent is used, but only in the final stage. In the initial stage, a multi-agent system is trained, therefore suffering from the problems stated in the previous paragraph.

A fuzzy system is used in “Fuzzy Rule-Based Reinforcement Learning for Load Balancing Techniques in Enterprise LTE Femtocells” as a continuous/discrete converter followed by a tabular RL algorithm. Nowadays there are more efficient ways to handle continuous states, like, for example, neural networks. On the one hand the number of discrete states grows exponentially with the number of variables that define the key performance indicator (KPI); and on the other hand it is necessary to go through all those states to train the system.

In some cases, like in “Online Antenna Tuning in Heterogeneous Cellular Networks with Deep Reinforcement Learning”, the action of the agent produces the final parameter value to be used. However, in general, RL techniques work better in an incremental way, in which the parameter is changed iteratively in small steps. A ‘final parameter’ approach is riskier, whereas increments provide less risk and are also better protected against other network changes that it is not possible for the RL agent to consider.

### SUMMARY OF THE INVENTION

Certain aspects of the present disclosure and their embodiments may provide solutions to the above or other challenges. In particular, techniques are provided for training a policy for use by reinforcement learning (RL) agents in optimising one or more cell parameters in cells of a network, where the policy is trained and the cell parameter(s) optimised using multiple instances of a single distributed RL agent (thus implicitly using the same policy), or using multiple RL agents that each use the same policy. This type of optimisation is considered as a complex network optimisation problem, as modification of a parameter in a single cell does not only affect the performance of that specific cell, but also that of surrounding cells.

According to a first aspect, there is provided a computer-implemented method of training a policy for use by a reinforcement learning, RL, agent in a communication network, wherein the RL agent is for optimising one or more cell parameters in a respective cell of the communication network according to the policy, the method comprising: (i) deploying a respective RL agent for each of a plurality of cells in the communication network, the plurality of cells including cells that are neighbouring each other, each respective RL agent having a first iteration of the policy; (ii) operating each deployed RL agent according to the first iteration of the policy to adjust or maintain one or more cell parameters in the respective cell; (iii) receiving measurements relating to the operation of each of the plurality of cells; and (iv) determining a second iteration of the policy based on the received measurements relating to the operation of each of the plurality of cells.

According to a second aspect, there is provided a computer program product comprising a computer readable medium having computer readable code embodied therein, the computer readable code being configured such that, on execution by a suitable computer or processor, the computer or processor is caused to perform the method according to the first aspect.

According to a third aspect, there is provided an apparatus for training a policy for use by a reinforcement learning, RL, agent in a communication network, wherein the RL agent is for optimising one or more cell parameters in a respective cell of the communication network according to the policy, the apparatus configured to: (i) deploy a respective RL agent for each of a plurality of cells in the communication network, the plurality of cells including cells that are neighbouring each other, each respective RL agent having a first iteration of the policy; (ii) operate each deployed RL agent according to the first iteration of the policy to adjust or maintain one or more cell parameters in the respective cell; (iii) receive measurements relating to the operation of each of the plurality of cells; and (iv) determine a second iteration of the policy based on the received measurements relating to the operation of each of the plurality of cells.

According to a fourth aspect, there is provided an apparatus for training a policy for use by a reinforcement learning, RL, agent in a communication network, wherein the RL agent is for optimising one or more cell parameters in a respective cell of the communication network according to the policy, the apparatus comprising a processor and a memory, said memory containing instructions executable by said processor whereby said apparatus is operative to: (i) deploy a respective RL agent for each of a plurality of cells in the communication network, the plurality of cells including cells that are neighbouring each other, each respective RL agent having a first iteration of the policy; (ii) operate each deployed RL agent according to the first iteration of the policy to adjust or maintain one or more cell parameters in the respective cell; (iii) receive measurements relating to the operation of each of the plurality of cells; and (iv) determine a second iteration of the policy based on the received measurements relating to the operation of each of the plurality of cells.

### BRIEF DESCRIPTION OF THE DRAWINGS

Various embodiments are described herein with reference to the following drawings, in which:

FIG. 1 is a graph comparing the performance of an expert system and an RL agent-system over time;

FIG. 2 shows a wireless network in accordance with some embodiments;

FIG. 3 shows a virtualisation environment in accordance with some embodiments;

FIG. 4 illustrates a deployment of multiple instances of an RL agent in a network;

FIG. 5 illustrates an exemplary reinforcement learning (RL) framework;

FIG. 6 illustrates an exemplary deep neural network for an RL agent;

FIG. 7 is a flow chart illustrating an exemplary training process for a RL agent policy according to some embodiments;

FIG. 8 illustrates a network environment in which an RL agent policy can be deployed;

FIG. 9 shows two graphs illustrating performance improvements in a network during training of a RL agent policy; and

FIG. 10 is a flow chart illustrating a method according to various embodiments.

### DETAILED DESCRIPTION OF THE PREFERRED EMBODIMENTS

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

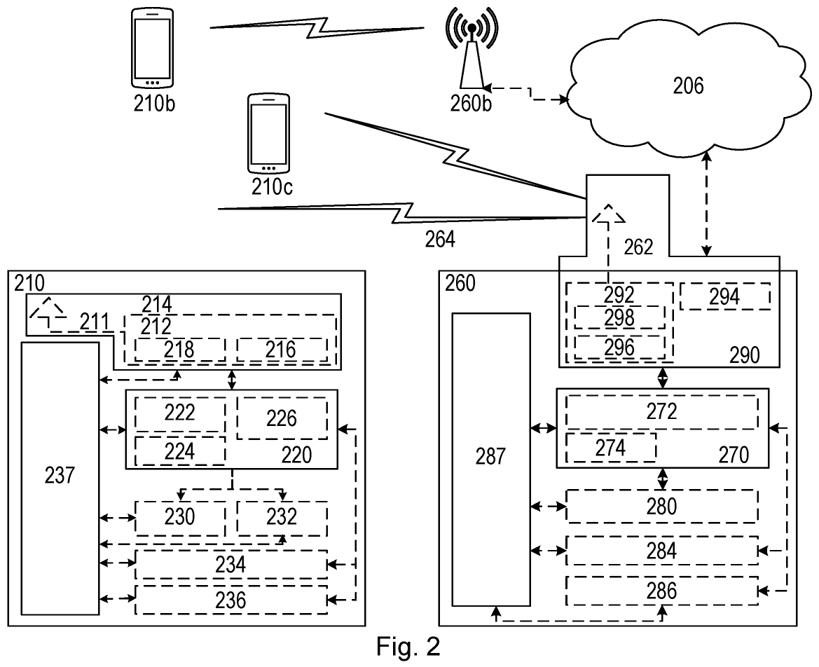

FIG. 2 shows part of a wireless network in accordance with some embodiments, and to which various embodiments of the disclosed techniques can be applied.

Although the subject matter described herein may be implemented in any appropriate type of system using any suitable components, the embodiments disclosed herein are described in relation to a wireless network, such as the example wireless network illustrated in FIG. 2. For simplicity, the wireless network of FIG. 2 only depicts network 206, network nodes 260 and 260b, and WDs 210, 210b, and 210c. In practice, a wireless network may further include any additional elements suitable to support communication between wireless devices or between a wireless device and another communication device, such as a landline telephone, a service provider, or any other network node or end device. Of the illustrated components, network node 260 and wireless device (WD) 210 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 206 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 260 and WD 210 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 2, network node 260 includes processing circuitry 270, device readable medium 280, interface 290, auxiliary equipment 284, power source 286, power circuitry 287, and antenna 262. Although network node 260 illustrated in the example wireless network of FIG. 2 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 260 are depicted as single boxes located within a larger box, or nested within multiple boxes, in practice, a network node may comprise multiple different physical components that make up a single illustrated component (e.g., device readable medium 280 may comprise multiple separate hard drives as well as multiple RAM modules).

Similarly, network node 260 may be composed of multiple physically separate components (e.g., a NodeB component and a RNC component, or a BTS component and a BSC component, etc.), which may each have their own respective components. In certain scenarios in which network node 260 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 260 may be configured to support multiple radio access technologies (RATs). In such embodiments, some components may be duplicated (e.g., separate device readable medium 280 for the different RATs) and some components may be reused (e.g., the same antenna 262 may be shared by the RATs). Network node 260 may also include multiple sets of the various illustrated components for different wireless technologies integrated into network node 260, such as, for example, GSM, WCDMA, LTE, NR, WiFi, or Bluetooth wireless technologies. These wireless technologies may be integrated into the same or different chip or set of chips and other components within network node 260.

Processing circuitry 270 is configured to perform any determining, calculating, or similar operations (e.g., certain obtaining operations) described herein as being provided by a network node. These operations performed by processing circuitry 270 may include processing information obtained by processing circuitry 270 by, for example, converting the obtained information into other information, comparing the obtained information or converted information to information stored in the network node, and/or performing one or more operations based on the obtained information or converted information, and as a result of said processing making a determination.

Processing circuitry 270 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 260 components, such as device readable medium 280, network node 260 functionality. For example, processing circuitry 270 may execute instructions stored in device readable medium 280 or in memory within processing circuitry 270. Such functionality may include providing any of the various wireless features, functions, or benefits discussed herein. In some embodiments, processing circuitry 270 may include a system on a chip (SOC). In some embodiments, processing circuitry 270 may include one or more of radio frequency (RF) transceiver circuitry 272 and baseband processing circuitry 274. In some embodiments, radio frequency (RF) transceiver circuitry 272 and baseband processing circuitry 274 may be on separate chips (or sets of chips), boards, or units, such as radio units and digital units. In alternative embodiments, part or all of RF transceiver circuitry 272 and baseband processing circuitry 274 may be on the same chip or set of chips, boards, or units

In certain embodiments, some or all of the functionality described herein as being provided by a network node, base station, eNB or other such network device may be performed by processing circuitry 270 executing instructions stored on device readable medium 280 or memory within processing circuitry 270. In alternative embodiments, some or all of the functionality may be provided by processing circuitry 270 without executing instructions stored on a separate or discrete device readable medium, such as in a hard-wired manner. In any of those embodiments, whether executing instructions stored on a device readable storage medium or not, processing circuitry 270 can be configured to perform the described functionality. The benefits provided by such functionality are not limited to processing circuitry 270 alone or to other components of network node 260, but are enjoyed by network node 260 as a whole, and/or by end users and the wireless network generally.

Device readable medium 280 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 270. Device readable medium 280 may store any suitable instructions, data or information, including a computer program, software, an application including one or more of logic, rules, code, tables, etc. and/or other instructions capable of being executed by processing circuitry 270 and, utilized by network node 260. Device readable medium 280 may be used to store any calculations made by processing circuitry 270 and/or any data received via interface 290. In some embodiments, processing circuitry 270 and device readable medium 280 may be considered to be integrated.

Interface 290 is used in the wired or wireless communication of signalling and/or data between network node 260, network 206, and/or WDs 210. As illustrated, interface 290 comprises port(s)/terminal(s) 294 to send and receive data, for example to and from network 206 over a wired connection. Interface 290 also includes radio front end circuitry 292 that may be coupled to, or in certain embodiments a part of, antenna 262. Radio front end circuitry 292 comprises filters 298 and amplifiers 296. Radio front end circuitry 292 may be connected to antenna 262 and processing circuitry 270. Radio front end circuitry may be configured to condition signals communicated between antenna 262 and processing circuitry 270. Radio front end circuitry 292 may receive digital data that is to be sent out to other network nodes or WDs via a wireless connection. Radio front end circuitry 292 may convert the digital data into a radio signal having the appropriate channel and bandwidth parameters using a combination of filters 298 and/or amplifiers 296. The radio signal may then be transmitted via antenna 262. Similarly, when receiving data, antenna 262 may collect radio signals which are then converted into digital data by radio front end circuitry 292. The digital data may be passed to processing circuitry 270. In other embodiments, the interface may comprise different components and/or different combinations of components.

In certain alternative embodiments, network node 260 may not include separate radio front end circuitry 292, instead, processing circuitry 270 may comprise radio front end circuitry and may be connected to antenna 262 without separate radio front end circuitry 292. Similarly, in some embodiments, all or some of RF transceiver circuitry 272 may be considered a part of interface 290. In still other embodiments, interface 290 may include one or more ports or terminals 294, radio front end circuitry 292, and RF transceiver circuitry 272, as part of a radio unit (not shown), and interface 290 may communicate with baseband processing circuitry 274, which is part of a digital unit (not shown).

Antenna 262 may include one or more antennas, or antenna arrays, configured to send and/or receive wireless signals 264. Antenna 262 may be coupled to radio front end circuitry 292 and may be any type of antenna capable of transmitting and receiving data and/or signals wirelessly. In some embodiments, antenna 262 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 262 may be separate from network node 260 and may be connectable to network node 260 through an interface or port.

Antenna 262, interface 290, and/or processing circuitry 270 may be configured to perform any receiving operations and/or certain obtaining operations described herein as being performed by a network node. Any information, data and/or signals may be received from a wireless device, another network node and/or any other network equipment. Similarly, antenna 262, interface 290, and/or processing circuitry 270 may be configured to perform any transmitting operations described herein as being performed by a network node. Any information, data and/or signals may be transmitted to a wireless device, another network node and/or any other network equipment.

Power circuitry 287 may comprise, or be coupled to, power management circuitry and is configured to supply the components of network node 260 with power for performing the functionality described herein. Power circuitry 287 may receive power from power source 286. Power source 286 and/or power circuitry 287 may be configured to provide power to the various components of network node 260 in a form suitable for the respective components (e.g., at a voltage and current level needed for each respective component). Power source 286 may either be included in, or external to, power circuitry 287 and/or network node 260. For example, network node 260 may be connectable to an external power source (e.g., an electricity outlet) via an input circuitry or interface such as an electrical cable, whereby the external power source supplies power to power circuitry 287. As a further example, power source 286 may comprise a source of power in the form of a battery or battery pack which is connected to, or integrated in, power circuitry 287. The battery may provide backup power should the external power source fail. Other types of power sources, such as photovoltaic devices, may also be used.

Alternative embodiments of network node 260 may include additional components beyond those shown in FIG. 2 that may be responsible for providing certain aspects of the network node's functionality, including any of the functionality described herein and/or any functionality necessary to support the subject matter described herein. For example, network node 260 may include user interface equipment to allow input of information into network node 260 and to allow output of information from network node 260. This may allow a user to perform diagnostic, maintenance, repair, and other administrative functions for network node 260.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as a Machine Type Communication (MTC) device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 210 includes antenna 211, interface 214, processing circuitry 220, device readable medium 230, user interface equipment 232, auxiliary equipment 234, power source 236 and power circuitry 237. WD 210 may include multiple sets of one or more of the illustrated components for different wireless technologies supported by WD 210, such as, for example, GSM, WCDMA, LTE, NR, WiFi, WiMAX, or Bluetooth wireless technologies, just to mention a few. These wireless technologies may be integrated into the same or different chips or set of chips as other components within WD 210.

Antenna 211 may include one or more antennas or antenna arrays, configured to send and/or receive wireless signals, and is connected to interface 214. In certain alternative embodiments, antenna 211 may be separate from WD 210 and be connectable to WD 210 through an interface or port. Antenna 211, interface 214, and/or processing circuitry 220 may be configured to perform any receiving or transmitting operations described herein as being performed by a WD. Any information, data and/or signals may be received from a network node and/or another WD. In some embodiments, radio front end circuitry and/or antenna 211 may be considered an interface.

As illustrated, interface 214 comprises radio front end circuitry 212 and antenna 211. Radio front end circuitry 212 comprise one or more filters 218 and amplifiers 216. Radio front end circuitry 212 is connected to antenna 211 and processing circuitry 220, and is configured to condition signals communicated between antenna 211 and processing circuitry 220. Radio front end circuitry 212 may be coupled to or a part of antenna 211. In some embodiments, WD 210 may not include separate radio front end circuitry 212; rather, processing circuitry 220 may comprise radio front end circuitry and may be connected to antenna 211. Similarly, in some embodiments, some or all of RF transceiver circuitry 222 may be considered a part of interface 214. Radio front end circuitry 212 may receive digital data that is to be sent out to other network nodes or WDs via a wireless connection. Radio front end circuitry 212 may convert the digital data into a radio signal having the appropriate channel and bandwidth parameters using a combination of filters 218 and/or amplifiers 216. The radio signal may then be transmitted via antenna 211. Similarly, when receiving data, antenna 211 may collect radio signals which are then converted into digital data by radio front end circuitry 212. The digital data may be passed to processing circuitry 220. In other embodiments, the interface may comprise different components and/or different combinations of components.

Processing circuitry 220 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 210 components, such as device readable medium 230, WD 210 functionality. Such functionality may include providing any of the various wireless features or benefits discussed herein. For example, processing circuitry 220 may execute instructions stored in device readable medium 230 or in memory within processing circuitry 220 to provide the functionality disclosed herein.

As illustrated, processing circuitry 220 includes one or more of RF transceiver circuitry 222, baseband processing circuitry 224, and application processing circuitry 226. In other embodiments, the processing circuitry may comprise different components and/or different combinations of components. In certain embodiments processing circuitry 220 of WD 210 may comprise a SOC. In some embodiments, RF transceiver circuitry 222, baseband processing circuitry 224, and application processing circuitry 226 may be on separate chips or sets of chips. In alternative embodiments, part or all of baseband processing circuitry 224 and application processing circuitry 226 may be combined into one chip or set of chips, and RF transceiver circuitry 222 may be on a separate chip or set of chips. In still alternative embodiments, part or all of RF transceiver circuitry 222 and baseband processing circuitry 224 may be on the same chip or set of chips, and application processing circuitry 226 may be on a separate chip or set of chips. In yet other alternative embodiments, part or all of RF transceiver circuitry 222, baseband processing circuitry 224, and application processing circuitry 226 may be combined in the same chip or set of chips. In some embodiments, RF transceiver circuitry 222 may be a part of interface 214. RF transceiver circuitry 222 may condition RF signals for processing circuitry 220.

In certain embodiments, some or all of the functionality described herein as being performed by a WD may be provided by processing circuitry 220 executing instructions stored on device readable medium 230, which in certain embodiments may be a computer-readable storage medium. In alternative embodiments, some or all of the functionality may be provided by processing circuitry 220 without executing instructions stored on a separate or discrete device readable storage medium, such as in a hard-wired manner. In any of those particular embodiments, whether executing instructions stored on a device readable storage medium or not, processing circuitry 220 can be configured to perform the described functionality. The benefits provided by such functionality are not limited to processing circuitry 220 alone or to other components of WD 210, but are enjoyed by WD 210 as a whole, and/or by end users and the wireless network generally.

Processing circuitry 220 may be configured to perform any determining, calculating, or similar operations (e.g., certain obtaining operations) described herein as being performed by a WD. These operations, as performed by processing circuitry 220, may include processing information obtained by processing circuitry 220 by, for example, converting the obtained information into other information, comparing the obtained information or converted information to information stored by WD 210, and/or performing one or more operations based on the obtained information or converted information, and as a result of said processing making a determination.

Device readable medium 230 may be operable to store a computer program, software, an application including one or more of logic, rules, code, tables, etc. and/or other instructions capable of being executed by processing circuitry 220. Device readable medium 230 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 220. In some embodiments, processing circuitry 220 and device readable medium 230 may be considered to be integrated.

User interface equipment 232 may provide components that allow for a human user to interact with WD 210. Such interaction may be of many forms, such as visual, audial, tactile, etc. User interface equipment 232 may be operable to produce output to the user and to allow the user to provide input to WD 210. The type of interaction may vary depending on the type of user interface equipment 232 installed in WD 210. For example, if WD 210 is a smart phone, the interaction may be via a touch screen; if WD 210 is a smart meter, the interaction may be through a screen that provides usage (e.g., the number of gallons used) or a speaker that provides an audible alert (e.g., if smoke is detected). User interface equipment 232 may include input interfaces, devices and circuits, and output interfaces, devices and circuits. User interface equipment 232 is configured to allow input of information into WD 210, and is connected to processing circuitry 220 to allow processing circuitry 220 to process the input information. User interface equipment 232 may include, for example, a microphone, a proximity or other sensor, keys/buttons, a touch display, one or more cameras, a USB port, or other input circuitry. User interface equipment 232 is also configured to allow output of information from WD 210, and to allow processing circuitry 220 to output information from WD 210. User interface equipment 232 may include, for example, a speaker, a display, vibrating circuitry, a USB port, a headphone interface, or other output circuitry. Using one or more input and output interfaces, devices, and circuits, of user interface equipment 232, WD 210 may communicate with end users and/or the wireless network, and allow them to benefit from the functionality described herein.

Auxiliary equipment 234 is operable to provide more specific functionality which may not be generally performed by WDs. This may comprise specialized sensors for doing measurements for various purposes, interfaces for additional types of communication such as wired communications etc. The inclusion and type of components of auxiliary equipment 234 may vary depending on the embodiment and/or scenario.

Power source 236 may, in some embodiments, be in the form of a battery or battery pack. Other types of power sources, such as an external power source (e.g., an electricity outlet), photovoltaic devices or power cells, may also be used. WD 210 may further comprise power circuitry 237 for delivering power from power source 236 to the various parts of WD 210 which need power from power source 236 to carry out any functionality described or indicated herein. Power circuitry 237 may in certain embodiments comprise power management circuitry. Power circuitry 237 may additionally or alternatively be operable to receive power from an external power source; in which case WD 210 may be connectable to the external power source (such as an electricity outlet) via input circuitry or an interface such as an electrical power cable. Power circuitry 237 may also in certain embodiments be operable to deliver power from an external power source to power source 236. This may be, for example, for the charging of power source 236. Power circuitry 237 may perform any formatting, converting, or other modification to the power from power source 236 to make the power suitable for the respective components of WD 210 to which power is supplied.

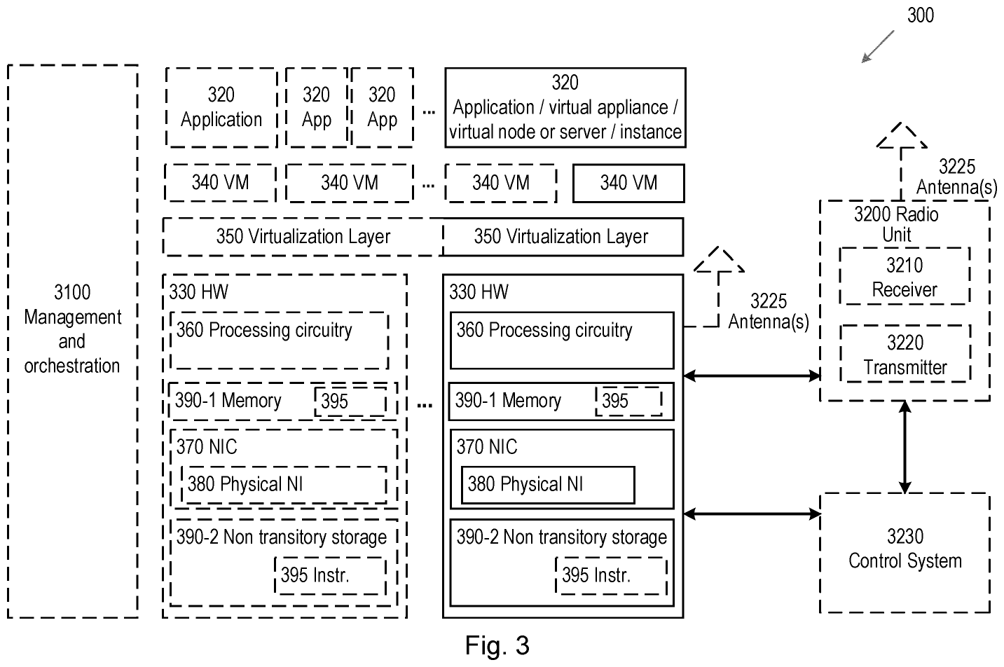

FIG. 3 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized core network node, a virtualized node, a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks). In some embodiments, the RL agents, and/or a control node for the RL agents, described herein can be implemented in or by a virtualization environment as shown in FIG. 3.

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 3, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 3.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

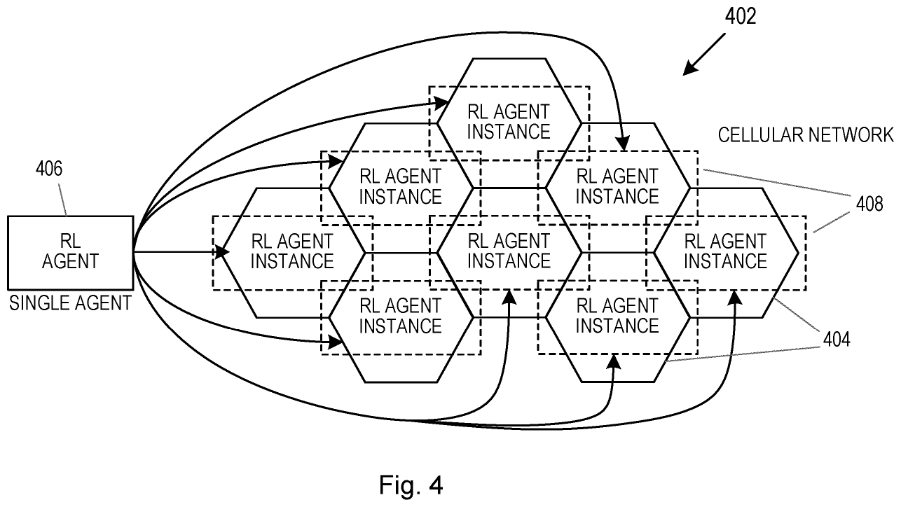

As noted above, embodiments of this disclosure propose a single distributed deep RL agent for complex network optimisation problems. Complex network optimisation problems include those in which modifying a network parameter in a single cell does not only affect the performance of that specific cell, but also that of the surrounding cells. In this approach, the same RL agent is distributed in multiples instances in cells in the network (or in some cases in every cell), and each RL agent instance controls a cell parameter for the specific cell for which it is deployed. FIG. 4 illustrates a deployment of multiple instances of an RL agent in a cellular network 402. The cellular network 402 is made up of a plurality of cells 404, which, simply for ease of illustration, are shown as non-overlapping hexagonal cells. Each cell will be managed and provided by a base station (e.g. an eNB or gNB), with each base station providing one or more cells 404. A single RL agent 406 is implemented that has a policy used by the RL agent 406 to determine if and how a cell parameter needs to be modified or adjusted. Respective instances 408 of the RL agent 406 are deployed to each cell 404, and thus each cell has a respective instance 408 of the RL agent 406 with the policy. Information relating to the cell parameter changes in each of the cells 404 is collected, including measurements relating to the operation of each of the cells 404, and this information is used to update the policy.

Thus, although one independent instance of the RL agent 406 is deployed per cell 404, the policy of each agent 406 is exactly the same, and it will be updated accordingly with the feedback (measurements, etc.) coming from all the RL agent instances 408. This is the concept of a single distributed agent, which implies deploying multiples instances 408 of the same agent 406. This makes the training phase easier because only a single unique policy must be trained.

It will be appreciated that an alternative way to view the deployment in FIG. 4 is that each RL agent instance 408 is a respective RL agent 406 that has the same policy as the other RL agents 406, with each agent's copy of the policy being updated as the policy is trained.

Since an action taken by an agent 406 in a cell 404 (e.g. increasing or decreasing the value of a cell parameter) does not only affect that cell 404 but also the surrounding (neighbouring) cells 404, it is necessary to have visibility of the cell 404 and its surrounding cells 404 in order to proceed in a proper way. Therefore, although the RL agent 406 is shown in FIG. 4 as logically distributed in all the cells 404, from an implementation point of view it is better that all the instances 408 are implemented in a centralised point where all the cells 404 report their status, which is accessible to all the agent instances 408. The centralised point can be in the core network (CN) part of the cellular network 402, or outside the cellular network 402.

Each RL agent 406/408 steers the cell parameters towards the optimal global solution by means of suggesting small incremental changes, while the single (shared) policy is updated accordingly with the feedback received from all the instances 408 of the RL agent 406.

The status of the cells 404 is typically composed or defined by continuous variables (parameters, KPIs, etc.), so tabular RL algorithms cannot be used directly. In the techniques described herein, deep neural networks can be used by the RL agent 406, because they can manage continuous variables in an inherent way.

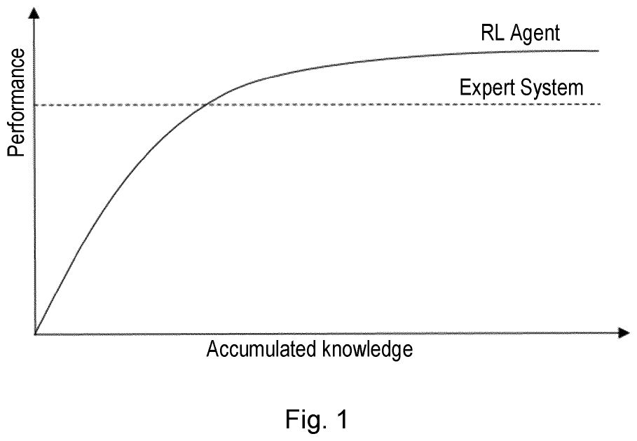

An RL agent 406 with a suitably trained policy can outperform any agent defined by an expert in terms of achieved performance in the long term. To avoid the initial policy training phase with its corresponding network degradation as illustrated in FIG. 1, an offline agent initialisation phase can be performed before putting the policy and RL agent 406 in place in the actual network. A principle can be to deploy an agent 406 which is similar to an expert-trained agent in terms of performance and, after that, allow it to be trained in order to improve the performance as much as possible. There are several ways in which this offline initialisation phase can be achieved: using a network simulator, using network data and using an expert system. This way, the transfer learning process is quite straightforward; the same trained agent 406 can be used when new cells 404 are integrated into the network 402; and, in the case of completely new network installations, the offline initialised agent can be used instead.

The single distributed RL agent approach described herein can provide one or more of the following advantages. The approach makes use of an RL agent so, in principle, it can outperform any agent based on rules defined by an expert. The approach does not cause network degradation during the initial phase of training (since the initialised RL agents are not deployed into the network), and instead there is a previous stage for offline agent initialisation. An offline initialised agent or the online trained agent are easily transferable to different networks or new integrated cells. The approach provides that the complexity of the training phase is reduced because only a unique agent policy must be trained. Moreover, the measurements/findings in the feedback coming from any of the agent instances is immediately available and used by the rest of instances to train the unique policy. The approach performs small incremental cell parameter changes which facilitates stability and convergence, and enables better adaptation to unexpected network changes. The approach can work with continuous states without the need of any adaptation layer, because of the usage of deep neural networks in various embodiments.

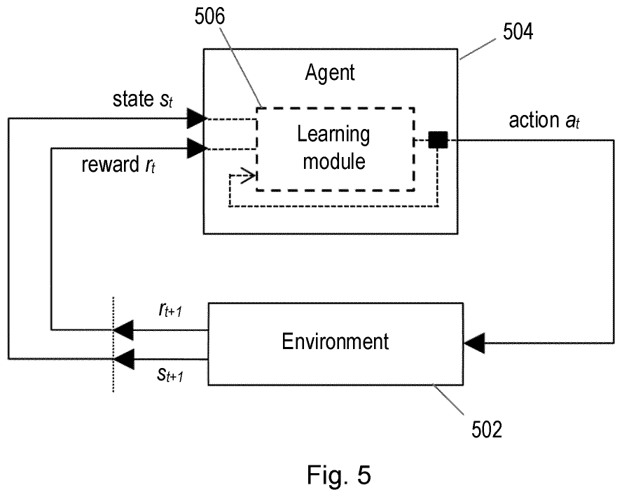

As noted above, RL is an area of machine learning concerned with how software agents ought to take actions in an environment in order to maximise a reward. FIG. 5 illustrates an exemplary RL framework, and more information can be found in “Reinforcement learning: An introduction” by Sutton, Richard S., and Andrew G. Barto, MIT press, 2018.

Basic reinforcement learning can be modelled as a Markov decision process, comprising an environment 502 (in this case, a cell 404 or the wider cellular network 402), an agent 504 having a learning module 506, a set of environment and agent states, S, and a set of actions, A, of the agent. The probability of a transition from state s to state s′ under action a is given by

P(s,a,s′)=Pr(sₜ₊₁=s′|sₜ=s,aₜ=a) (1)

and an immediate reward after a transition from s to s′ with action a is given by

r(s,a,s′) (2)

RL agent 504 interacts with its environment 502 in discrete time steps. At each time t, the agent 504 receives an observation oₜ, which typically includes the reward rₜ. It then selects an action aₜ from the set of available actions A, which is subsequently applied onto the environment 502. The environment 502 moves to a new state sₜ₊₁ and the reward rₜ₊₁ associated with the transition (sₜ, aₜ, sₜ₊₁) is determined. The goal of the RL agent 504 is to collect as much reward as possible.

The selection of the action by the agent is modelled as a map called ‘policy’, which is given by:

π:A×S→[0,1] (3)

π(a,s)=Pr(aₜ=a|sₜ=s) (4)

The policy map gives the probability of taking action a when in state s. Given a state s, an action a and a policy π, the action-value of the pair (s, a) under π is defined by:

Q^{π}(s,a)=E[R|s,a,π] (5)

where the random variable R denotes the return, and is defined as the sum of future discounted rewards

R=Σₜ₌₀^{∞}γ^{t}rₜ (6)

where rₜ is the reward at step t and γ in [0,1] is the discount-rate.

The theory of Markov Decision Processes states that if π* is an optimal policy, acting optimally (i.e. taking the optimal action) is carried out by choosing the action from Q^{π*}(s,⋅) with the highest value at each state, s. The action-value function of such optimal policy (Q^{π*}) is called the optimal action-value function and is commonly denoted by Q*. In summary, the knowledge of the optimal action-value function alone suffices to know how to act optimally.

Assuming full knowledge of the Markov Decision Process, the two basic approaches to compute the optimal action-value function are value iteration and policy iteration. Both algorithms compute a sequence of functions Qₖ(k=0, 1, 2, . . . ) that converge to Q*. Computing these functions involves computing expectations over the whole state-space, which is impractical for all but the smallest (finite) Markov Decision Processes. In RL methods, expectations are approximated by averaging over samples and using function approximation techniques to cope with the need to represent value functions over large state-action spaces. One of the most used RL methods is Q-Learning.

As noted above, embodiments of this disclosure propose a single distributed deep RL agent for complex network optimisation problems. Complex network optimisation problems include those in which modifying a network parameter in a single cell does not only affect the performance of that specific cell, but also that of the surrounding cells in a manner that is not easy to predict in advance. The target is to achieve a performance target at network level, by modifying individual cell parameters. In this approach, the same RL agent is distributed in multiples instances in cells in the network (or in some cases in every cell), and each RL agent instance controls a cell parameter for the specific cell for which it is deployed. Some examples of the cell parameters are the Remote Electrical Tilt (RET) and the P0 Nominal PUSCH as defined above, the transmission power of the base station (eNB or the gNB), and, for the case of LTE, the Cell-Specific Reference Signal (CSRS) gain.

With the objective of configuring the cell parameters so that the network outperforms a network configured by an agent implementing rules defined by an expert, the core of the techniques described herein is an RL agent 504 having a framework as shown in FIG. 5. The RL agent 504 is deployed as a single distributed agent, which means that the agent definition is unique, i.e. the policy is the same, but an agent instance exists per cell of interest in the cellular network (it should be noted that it is not necessary to deploy an agent for each cell in the network, although it is possible to do so). In practice, this means that, although there is a unique agent definition, it is accessed and trained simultaneously by feedback from multiple cells. This is illustrated in FIG. 4, as described above. Each agent instance will optimise the cell for which it is deployed by modifying a certain parameter in the cell. Typically, the possible actions that can be performed by an agent with respect to a cell parameter are: do nothing, i.e. do not modify the cell parameter and maintain the current value of the cell parameter; increase the parameter value by a small incremental step, i.e. increase the value of the cell parameter by an incremental amount; and decrease the parameter value by a small incremental step, i.e. decrease the value of the cell parameter by an incremental amount.

The cell parameter, in an iteration, may only be modified by a small incremental step in order to facilitate the convergence of the agent learning process to an optimised configuration. Also, as the agent definition is unique only a single policy must be trained, which helps the learning process. Additionally, this slow ‘parameter steering’ process can better react against uncontrollable/unexpected changes in the network, e.g. temporary drastic changes in the offered traffic due to a massive event (e.g. a sports event or concert).

Since the parameter change does not only affect the cell of interest in which the parameter is changed but also one or more of the neighbouring cells, the status of the environment(s) 502 should be composed of features/measurements from the main cell (i.e. the cell of interest) as well as from the surrounding/neighbouring cells. In general, these features/measurements will be extracted from cell parameters and cell KPIs.

In this way, a single agent instance must have access to features/measurements coming from different cells.

The ‘reward’ in the RL process should reflect the performance improvement (positive value) or degradation (negative value) that the action (parameter change) is generating in the environment (network). Two options are possible for the reward. The reward can be a local reward that is based on performance improvement/degradation in the modified cell and its neighbour cells. Alternatively the reward can be a global reward that is based on a performance improvement/degradation in the whole network.

Training the RL agent 504 consists in learning the Q(s, a) function for all the possible states and actions. The actions are typically three in this case (i.e. maintain, increase and decrease), but the state is composed of N continuous features, giving an infinite number of possible states. A tabular function for Q may not be the most appropriate approach for this agent. Although a continuous/discrete converter might be included as a first layer, the usage of a deep neural network is more suitable, because it handles continuous features directly.

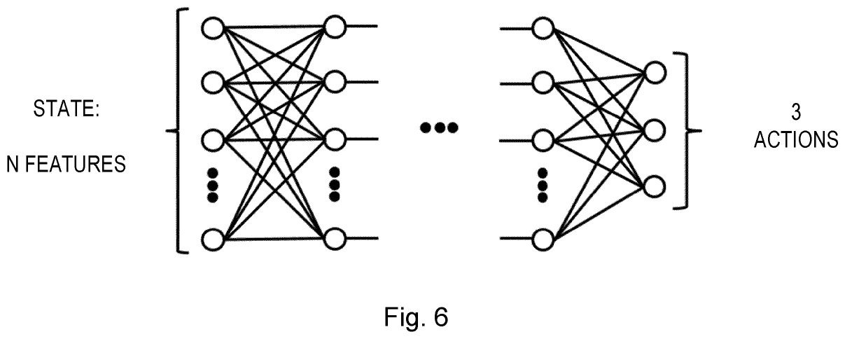

FIG. 6 illustrates an exemplary architecture of a deep neural network. Given a state s represented by N continuous features, the output of the neural network is the Q value for the 3 possible actions. The problem, when expressed in this way, is reduced to a regression problem.

One method to resolve this regression problem is Q-Learning, which consists of generating tuples (state, action, reward, next state)=(s, a, r, s) and solve the following supervised learning problem iteratively:

$$Q ( s , a ) = r + γ {max}_{{a}^{′}} Q ( {s}^{′} , {a}^{′} ) \qquad ( 7 )$$

Actions to generate the tuples can be selected in any way, but a very common method is to use what is called ‘epsilon-greedy policy’ in which a hyperparameter epsilon (c) in the range [0, 1] controls the balance between exploration (where the action is selected randomly) and exploitation (the best action is selected, this is,

$${arg max}_{a} Q ( s , a ) ) .$$

Q-Learning is a well-known algorithm in RL, but other available methods can be used here, such as State-Action-Reward-State-Action (SARSA), Expected Value SARSA (EV-SARSA), Reinforce Baseline, and Actor-critic.

As noted, the agent 504 acts (i.e. changes the parameter value of) on a single cell, but this change can affect the performance of several more cells. Thus, the reward observed by an agent instance 504 does not only depend on the action taken by that agent 504, but also on other agents 504 acting at the same time for different cells. This is an issue to be solved which does not occur in a standard RL problem.

In this disclosure, the problem is addressed by training a unique policy, taking, at every training step, a batch of samples/measurements; where each sample/measurement is the outcome of the interaction of an agent instance 504 with its cell. Using this approach, the training converges to a single policy which is the best common policy for all of the agents in the network.

Another issue that occurs when training an RL agent is the poor performance at the beginning of the training phase, because the initial agent policy can just be a random policy. In this disclosure, in order to overcome this issue, in certain embodiments an agent pre-initialisation phase is included. This way, the performance of the agent when it is deployed in the network can be like any expert system. There are three different options for this offline pre-initialisation. The first is to use a network simulator for initial training, where network degradation does not have any real negative impact. The second is to use supervised learning and train the agent to make it behave in the same or similar way as an expert system. The third is to obtain data from a network where the cell parameter has been modified widely for some purpose. In this way, using an offline RL method where the policy to explore the environment does not have to be necessarily the same as the policy under learning (Q-Learning or EV-SARSA), an agent implementing an optimal policy can be trained.

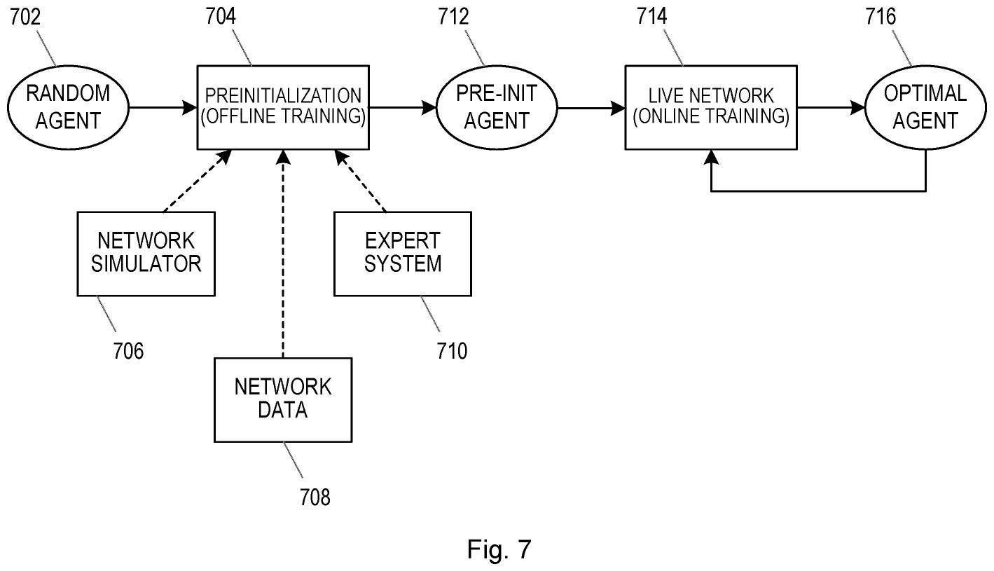

FIG. 7 is a flow chart illustrating an exemplary training process for a RL agent policy according to some embodiments. Block 702 represents the state of an RL agent that has a random policy. This random agent 702 enters a pre-initialisation phase 704 in which the agent 702 is trained offline (i.e. separate from the actual network). The pre-initialisation 704 can use any of network simulator 706 (the first approach), network data 708 (the third approach) and an existing expert system 710 (the second approach). This results in pre-initialised agent 712 that is deployed in the network. Thus, instances of the pre-initialised agent 712 are deployed in each cell of interest (or all cells) in the network. The deployed agent/instances are then trained using the network (block 714) to result in an agent having an optimised policy (optimal agent 716).

In the event that the agent is already deployed in the network and new cells are integrated or added into the network, new instances of the already trained agent are created to manage the cell parameter(s) in the new cells. Thus, using these techniques, the transfer learning process is quite straightforward.

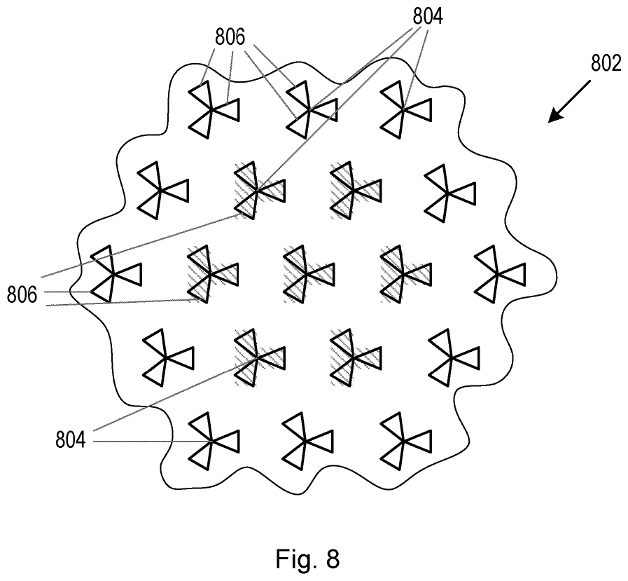

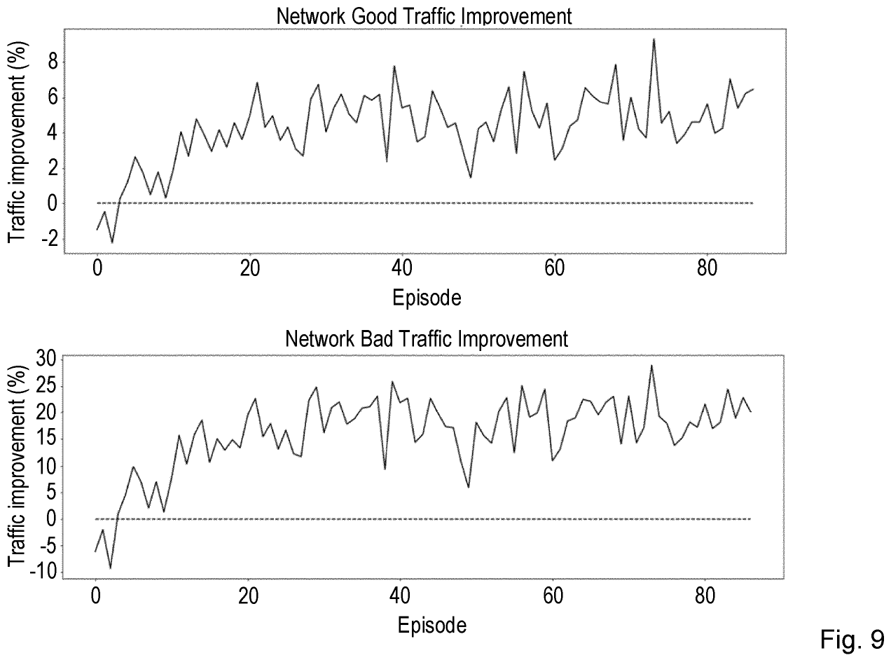

FIG. 8 illustrates a network environment in which an exemplary RL agent policy can be deployed and trained, and FIG. 9 shows two graphs illustrating performance improvements in a network during training of a RL agent policy.

FIG. 8 shows a network 802 that includes a number (19 in this example) of base stations 804. Each base station 804 defines or controls one or more (directional) cells 806 (with three cells 806 per base station 804 in FIG. 8). In this example, only the cells 806 in the central 7 sites/base stations 804 of the network 802 (the shaded cells) are actively managed by instances of the RL agent. The outer 12 sites/base stations 804 (the non-shaded cells) are not actively managed by instances of the RL agent. However, for training and optimisation, the performance of the whole (global) network is measured, so considering the whole set of 19 sites.

As in FIG. 4, the cells 804, 806 are set out in a uniform distribution, but it will be appreciated that in practice there will be overlaps and/or gaps between neighbouring cells.

In the example of FIGS. 8 and 9, the cell parameter to be optimised by the agents is RET, the cellular network 802 is represented by a LTE static simulator, the RL method is Q-Learning, the reward is a global reward, and the policy is an epsilon-greedy policy, where epsilon focuses on randomness at the beginning, and on greedy (optimal) at the end.

The training phase (steps 702-712 in FIG. 7) is performed by running consecutive episodes, where an episode is performed for a particular network configuration (i.e. in terms of cell deployment, etc.). An episode starts with an initialisation of the network cluster with random RET values in all the cells, in the range [0, 10] degrees. In every training step, each agent instance selects one action (nothing, small increase or small decrease) for the optimisable parameter of the respective cell and the feedback/measurements from that cell and the neighbouring cells are used for the training (in a single training step) of the neural network. Steps can be executed until the episode converges and each agent selects the action ‘nothing’ for all the cells. Alternatively steps can be executed until a maximum number of steps has been reached. In either case, the episode, at this point, is considered to be complete and a new episode (network configuration) is created from the beginning in order to continue with the training phase. An episode can therefore be perceived as a reduced network optimisation campaign. The learning (i.e. the trained policy) within the agent is preserved when moving from one episode to the next one.

For the environment and agent states, the features/measurements obtained can be as described in “Self-tuning of Remote Electrical Tilts Based on Call Traces for Coverage and Capacity Optimization in LTE”. In particular, measurements can relate to “Cell Overshooting” which occurs in cell X when users served by other cells report signal levels from cell X close to the signal levels from their serving cell; “Useless High-level Cell Overlapping” which occurs when a neighbour cell is received with a Reference Signal Received Power (RSRP) level close to that of the serving cell, when the latter is very high; and “Bad Coverage” which is a proposed indicator intended to detect situations of lack of coverage at cell edges.

In addition to the previous indicators, other configuration parameters are also included in the state like frequency, inter-site distance or antenna height.

The reward is based on the improvement (positive value) or degradation (negative value) in the amount of ‘good’ served traffic in the whole network 802. Traffic is considered ‘good’ if the RSRP is higher than a threshold and DL SINR is higher than a separate threshold. Both thresholds are considered as hyper parameters. Likewise, traffic is considered ‘bad’ if the RSRP is lower than the threshold or DL SINR is lower than a separate threshold.

Training results can be observed in FIG. 9. 1500 training steps were executed in which 87 full episodes were run. The top graph shows the percentage improvement in ‘good’ traffic, and the bottom graph shows the percentage improvement in ‘bad’ traffic (corresponding to a reduction in bad traffic). A single point in each graph represents the good/bad traffic improvement between the start and the end of a particular episode. It will be noted that during the first few episodes the agent/policy shows very bad performance, causing even degradation to the network, because the agent is initialised randomly. Over several episodes, the agent starts to learn/be trained and, at the end, in the later episodes the agent is very close to the optimal policy. The average per episode improvement is around 5% for good traffic and 20% for bad traffic.

Thus, the use of multiple distributed instances of a single deep RL agent is proposed to solve the cellular network optimisation problem in which modifying a parameter in a cell does not only affect the performance of that cell, but also that of all the surrounding cells.

At every training step, an instance of the same agent (same policy) is executed in the cells, providing enough feedback to create a batch over which a deep neural network contained in the agent will be optimised (in one single step) iteratively. This way, the learning convergence is facilitated, since a unique and common policy is trained.

Defining a single agent, but using multiple distributed instances of the agent that act on different cells (considering the status of those cells and their surrounding cells), makes the process of transfer learning (applying the agent to new cells) relatively straightforward.

Finally, in some embodiments, a pre-initialisation phase for the agent can be used, with the objective of avoiding the initial learning phase that is typical in RL in which the agent provides poor performance that causes significant network degradation if applied directly to a live network.

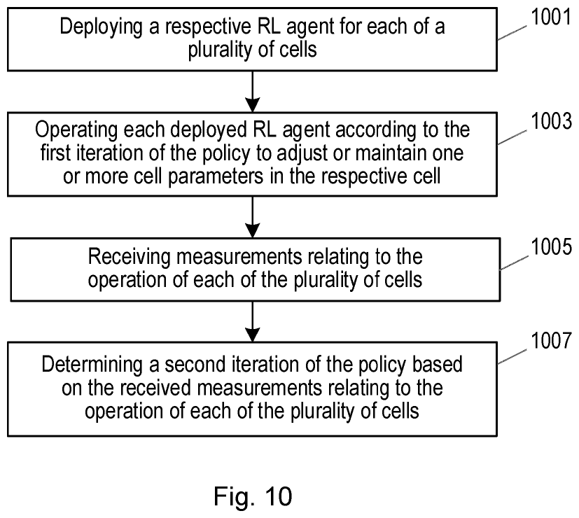

The flow chart in FIG. 10 illustrates a method according to various embodiments for training a policy for use by a RL agent in a communication network. The RL agent is for optimising one or more cell parameters in a respective cell of the communication network according to the policy. The exemplary method and/or procedure shown in FIG. 10 can be performed by a RL agent or network node that is part of, or associated with, the communication network, such as described herein with reference to other figures. Although the exemplary method and/or procedure is illustrated in FIG. 10 by blocks in a particular order, this order is exemplary and the operations corresponding to the blocks can be performed in different orders, and can be combined and/or divided into blocks and/or operations having different functionality than shown in FIG. 10. Furthermore, the exemplary method and/or procedure shown in FIG. 10 can be complementary to other exemplary methods and/or procedures disclosed herein, such that they are capable of being used cooperatively to provide the benefits, advantages, and/or solutions to problems described hereinabove.

The exemplary method and/or procedure can include the operations of block 1001, in which a respective RL agent is deployed for each of a plurality of cells in the communication network. The plurality of cells includes cells that are neighbouring each other. Each respective RL agent has a first iteration of the policy. In some embodiments, each respective RL agent is a respective instance of a single RL agent. In alternative embodiments, step 1001 comprises deploying respective, separate, RL agents for each of the plurality of cells, with each separate RL agent having a respective copy of the first iteration of the policy. In some embodiments each RL agent or RL agent instance can be deployed in each cell (or in a respective base station in each cell), but in preferred embodiments each RL agent or RL agent instance is deployed in a centralised node in the network or external to the network.

The exemplary method and/or procedure can include the operations of block 1003, in which each deployed RL agent is operated according to the first iteration of the policy to adjust or maintain one or more cell parameters in the respective cell.

The exemplary method and/or procedure can include the operations of block 1005, in which measurements are received relating to the operation of each of the plurality of cells.

The exemplary method and/or procedure can include the operations of block 1007, in which a second iteration of the policy can be determined based on the received measurements relating to the operation of each of the plurality of cells.

Some exemplary embodiments can further comprise repeating step 1003 using the second iteration of the policy. That is, each deployed RL agent is operated according to the second iteration of the policy to further adjust or maintain the one or more cell parameters in the respective cell.

In some embodiments, the method can further comprise repeating steps 1005 and 1007 to determine a third iteration of the policy. That is, measurements are received relating to the operation of each of the plurality of cells following the further adjustment of the one or more cell parameters, and the third iteration of the policy is determined based on the received measurements relating to the operation of each of the plurality of cells.

In some embodiments, the method can generally further comprise repeating steps 1003, 1005 and 1007 to determine further iterations of the policy.

In some embodiments, steps 1003, 1005 and 1007 are repeated a predetermined number of times. In alternative embodiments, steps 1003, 1005 and 1007 are repeated until each deployed RL agent maintains the one or more cell parameters in the respective cell in an occurrence of step 1003. In other alternative embodiments, steps 1003, 1005 and 1007 are repeated until a predetermined number or predetermined proportion of the deployed RL agents maintain the one or more cell parameters in the respective cell in an occurrence of step 1003. In other alternative embodiments, steps 1003, 1005 and 1007 are repeated until a predetermined number or predetermined proportion of the deployed RL agents reverse an adjustment to the one or more cell parameters in the respective cell in successive occurrences of step 1003. This final alternative relates to a situation where a particular RL agent increments the cell parameter in one occurrence of step 1003, decrements the cell parameter by the same amount in the next occurrence of step 1003 and then increments the cell parameter again in the next occurrence. In effect, the RL agent is oscillating the cell parameter around an ‘ideal’ value that is not selectable in practice; and when a sufficient number of the RL agents are in this ‘oscillating’ state the training of the policy can be stopped.

In some embodiments, the second (and further) iterations of the policy are determined using RL techniques. For example, the second (and further) iterations of the policy are determined using a Deep Neural Network.

In some embodiments, step 1007 comprises determining the second iteration of the policy to increase a local reward relating to performance of a respective cell and one or more cells neighbouring the respective cell. In alternative embodiments, step 1007 comprises determining the second iteration of the policy to increase a global reward relating to performance of the communication network.

In some embodiments, step 1003 comprises, for each of the one or more cell parameters, one of maintaining a value of the cell parameter, increasing the value of the cell parameter, and decreasing the value of the cell parameter.

In some embodiments, the one or more cell parameters relate to downlink transmissions to wireless devices in the cell. In some embodiments, the one or more cell parameters comprise an antenna tilt of an antenna for the cell.

In some embodiments, the one or more cell parameters relate to uplink transmissions from wireless devices in the cell. In some embodiments, the one or more cell parameters comprises a target power level expected for uplink transmissions.

In some embodiments, step 1005 comprises receiving measurements relating to uplink transmissions in the plurality of cells. In some embodiments, step 1005 comprises (or further comprises) receiving measurements relating to downlink transmissions in the plurality of cells.

In some embodiments, step 1005 comprises receiving measurements relating to the operation of one or more other cells neighbouring any of the plurality of cells. These other cells are cells for (or in) which an RL agent is not deployed.

As noted, the exemplary method and/or procedure shown in FIG. 10 can be performed by a RL agent or network node that is part of, or associated with, the communication network. Embodiments of this disclosure provide a network node or RL agent configured to perform the method in FIG. 10 or any embodiment of the method presented in this disclosure. Other embodiments of this disclosure provide a network node or RL agent comprising a processor and a memory, e.g. processing circuitry 270 and device readable medium 280 in FIG. 2 or processing circuitry 360 and memory 390-1 in FIG. 3, with the memory containing instructions executable by the processor so that the network node or RL agent is operative to perform the method in FIG. 10 or any embodiment of that method presented in this disclosure.

As described herein, a device or apparatus such as an RL agent or network node can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Although the term “cell” is used herein, it should be understood that (particularly with respect to 5G NR) beams may be used instead of cells and, as such, concepts described herein apply equally to both cells and beams. The use of “cell” or “cells” herein should therefore be understood as referring to cells or beams as appropriate.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1.-55. (canceled)

56. A computer-implemented method of training a policy for use by reinforcement learning (RL) agents to optimize one or more cell parameters of respective cells of a communication network, the method comprising the following operations:
(i) deploying a plurality of RL agents associated with a respective plurality of cells in the communication network, wherein the plurality of cells include cells that are neighboring each other, wherein each RL agent is deployed with a first iteration of the policy;
(ii) operating the plurality of deployed RL agents according to the first iteration of the policy to adjust or maintain one or more cell parameters in the respective plurality of cells;
(iii) receiving measurements relating to the operation of each of the plurality of cells; and
(iv) determining a second iteration of the policy based on the received measurements relating to the operation of each of the plurality of cells.

57. A method as claimed in claim 56, wherein operations (ii), (iii) and (iv) are repeated to determine successive iterations of the policy, wherein operation (ii) in each repetition is performed according to the iteration of the policy determined in operation (iv) of the most recent repetition, wherein operations (ii), (iii) and (iv) are repeated until one of the following:
a predetermined number of repetitions have been performed;
each deployed RL agent maintains the one or more cell parameters in the associated cell in an occurrence of operation (ii);
a predetermined number or predetermined proportion of the deployed RL agents maintain the one or more cell parameters in the plurality of cells in an occurrence of operation (ii); or
a predetermined number or predetermined proportion of the deployed RL agents reverse an adjustment to the one or more cell parameters in the respective cell in successive occurrences of operation (ii).

58. A method as claimed in claim 56, wherein one of the following applies:
the plurality of RL agents are a plurality of instances of a single RL agent; or
the plurality of RL agents are separate RL agents associated with the respective cells, and each separate RL agent has a respective copy of the first iteration of the policy.

59. A method as claimed in claim 56, wherein operation (iv) comprises determining the second iteration of the policy using one of the following: RL techniques, or a Deep Neural Network.

60. A method as claimed in claim 56, wherein the determined second iteration of the policy increases one of the following:
a local reward relating to performance of a respective cell and one or more cells neighbouring the respective cell; or
a global reward relating to performance of the communication network.

61. A method as claimed in claim 56, wherein operation (ii) comprises, for each of the one or more cell parameters in each of the plurality of cells, maintaining a value of the cell parameter, increasing a value of the cell parameter, and decreasing a value of the cell parameter.

62. A method as claimed in claim 56, wherein in each of the plurality of cells, the one or more cell parameters relate to one of the following: downlink transmissions to wireless devices in the cell, or uplink transmissions from wireless devices in the cell

63. A method as claimed in claim 62, wherein:
when the one or more cell parameters relate to downlink transmissions, the one or more cell parameters comprises an antenna tilt of an antenna for the cell; and
when the one or more cell parameters relate to uplink transmissions, the one or more cell parameters comprises a target power level expected for uplink transmissions.

64. A method as claimed in claim 56, wherein the received measurements relate to one or more of the following:
uplink transmissions in the plurality of cells;
downlink transmissions in the plurality of cells; and
operation of one or more other cells neighbouring any of the plurality of cells, wherein RL agents are not deployed in the one or more other cells.

65. An apparatus configured for training a policy for use by reinforcement learning (RL) agents to optimize one or more cell parameters of respective cells of a communication network, the apparatus comprising:
processing circuitry; and
a non-transitory storage medium operably coupled to the processing circuitry and containing instructions that, when executed by the processing circuitry, configure the apparatus to perform the following operations:
(i) deploy a plurality of RL agents associated with a respective plurality of cells in the communication network, wherein the plurality of cells include cells that are neighboring each other, wherein each RL agent is deployed with a first iteration of the policy;
(ii) operate the plurality of deployed RL agents according to the first iteration of the policy to adjust or maintain one or more cell parameters in the respective plurality of cells;
(iii) receive measurements relating to the operation of each of the plurality of cells; and
(iv) determine a second iteration of the policy based on the received measurements relating to the operation of each of the plurality of cells.

66. The apparatus of claim 65, wherein execution of the instructions further configures the apparatus to repeat operations (ii), (iii) and (iv) to determine successive iterations of the policy, wherein operation (ii) in each repetition is performed according to the iteration of the policy determined in operation (iv) of the most recent repetition, wherein execution of the instructions further configures the apparatus to repeat operations (ii), (iii) and (iv) until one of the following:
a predetermined number of repetitions have been performed;
each deployed RL agent maintains the one or more cell parameters in the associated cell in an occurrence of operation (ii);
a predetermined number or predetermined proportion of the deployed RL agents maintain the one or more cell parameters in the plurality of cells in an occurrence of operation (ii); or
a predetermined number or predetermined proportion of the deployed RL agents reverse an adjustment to the one or more cell parameters in the respective cell in successive occurrences of operation (ii).

67. The apparatus of claim 65, wherein one of the following applies:
the plurality of RL agents are a plurality of instances of a single RL agent; or
the plurality of RL agents are separate RL agents associated with the respective cells, and each separate RL agent has a respective copy of the first iteration of the policy.

68. The apparatus of claim 65, wherein execution of the instructions configures the apparatus to determine the second iteration of the policy using one of the following: RL techniques, or a Deep Neural Network.

69. The apparatus of claim 65, wherein the determined second iteration of the policy increases one of the following:
a local reward relating to performance of a respective cell and one or more cells neighbouring the respective cell; or
a global reward relating to performance of the communication network.

70. The apparatus of claim 65, wherein execution of the instructions configures the apparatus to adjust or maintain the one or more cell parameters in the respective plurality of cells based on one of the following for each of the one or more cell parameters in each of the plurality of cells: maintaining a value of the cell parameter, increasing a value of the cell parameter, or decreasing a value of the cell parameter.

71. The apparatus of claim 65, wherein in each of the plurality of cells, the one or more cell parameters relate to one of the following: downlink transmissions to wireless devices in the cell, or uplink transmissions from wireless devices in the cell

72. The apparatus of claim 71, wherein:
when the one or more cell parameters relate to downlink transmissions, the one or more cell parameters comprises an antenna tilt of an antenna for the cell; and
when the one or more cell parameters relate to uplink transmissions, the one or more cell parameters comprises a target power level expected for uplink transmissions.

73. The apparatus of claim 65, wherein the received measurements relate to one or more of the following:
uplink transmissions in the plurality of cells;
downlink transmissions in the plurality of cells; and
operation of one or more other cells neighbouring any of the plurality of cells, wherein RL agents are not deployed in the one or more other cells.

74. A non-transitory, computer-readable medium storing computer-executable instructions that, when executed by processing circuitry of an apparatus configured for training a policy for use by reinforcement learning (RL) agents to optimize one or more cell parameters of respective cells of a communication network, configure the apparatus to perform operations corresponding to the method of claim 56.
